(19) United States
(12) Patent Application Publication
(10) Pub. No.: US 2011/0303694 A1
(43) Pub. Date: Dec. 15, 2011

(54) FOAM DISPENSER

(75) Inventor: Alexandre Pié, Laval (CA)

(73) Assignee: Ivex Protective Packaging , Inc., Bridgeview, IL (US)

(21) Appl. No.: 13/160,327

(22) Filed: Jun. 14, 2011

Related U.S. Application Data
(60) Provisional application No. 61/354,540, filed on Jun. 14, 2010.

(51) Int. Cl. B67D 7/22; B23P 6/00; B05B 7/16; B05B 7/26

(52) U.S. Cl. 222/41; 222/145.5; 222/23; 29/402.08; 222/94; 222/137; 222/333

(57) ABSTRACT

The present disclosure relates generally to a standing foam dispenser, and more particularly, to a foam dispenser with a nozzle assembly having a disposable nozzle adapted for easy removal and replacement.

### RELATED APPLICATIONS

This application is a Non-Provisional patent application and claims the benefit of and the priority from U.S. Provisional Patent Application No. 61/354,540, filed Jun. 14, 2010, entitled FOAM DISPENSER, which is expressly incorporated herein by reference.

### FIELD OF THE DISCLOSURE

The present disclosure relates generally to a standing foam dispenser, and more particularly, to a foam dispenser with a nozzle assembly having a disposable nozzle adapted for easy removal and replacement.

### BACKGROUND

On Mar. 29, 2005, International Patent Applications were filed claiming priority from two Provisional Patent Applications Nos. 60/556,883 filed on Mar. 29, 2004, and 61/114,078 filed on Nov. 13, 2008 respectively. These Applications were titled Self Contained Foam Dispenser (Application No. PCT/IL2005/000356), Foam Dispenser Nozzle (Application No. PCT/IL2005/000355), and Apparatus and Method for Packaging (Application No. PCT/IL2009/001070) respectively. These Non-Provisional Patent Applications are incorporated herein fully by reference. U.S. Provisional Patent Applications Nos. 60/556,883, and 61/114,078 are also incorporated herein fully by reference.

Foam materials are commonly used in packaging and other industries. The foam is generated by mixing two chemical components which harden within about 10 to 30 seconds from the time of mixture, thus creating a rigid casing protection for an item located into the rigidifying foam. The foam then acts as packing material absorbing shocks during transportation.

In many cases, a foam dispensing device, such as a gun, is used to generate the foam at packaging sites. The item to be shipped is manually placed inside a large container such as a box, and the empty space between the inside of the box and the item is filled with the expanding foam confined by a plastic bag. The foam technology can be used alternatively to other known packaging technologies such as small packing chips, a sheet of bubble wrap, or other lose packing material. U.S. Pat. No. 4,262,848 (“Chabria”), and U.S. Pat. No. 5,462,204 (“Fiin”) describe the use of foam guns to produce the packaging foam. Both these references are hereby incorporated by reference. These guns generally include pumps, one to control the flow of each of the two chemical components to be mixed to form the packaging foam to precise and required amounts to achieve the proper mix. The chemical compounds forming the foam can also be heated using heating coils to achieve a better mix or to change the time for hardening of the foam.

In other foam producing devices, instead of using a pump driven by a motor, the device uses pressurized air or gas in vessels. One reference describing the use of pressure driven foam components from storage vessels is U.S. Pat. No. 3,178,157 (“Cole”) incorporated herein fully by reference. In another reference, namely U.S. Pat. No. 5,348,392 (“Bouquet et al.”) also using pressure driven storage vessels, separate pressurized receptacles are pierced and the components mix in a mixing chamber and expelled in a passageway. Using such a technology to produce the mixture results in difficulties to control the proportion of each of the chemicals at the mixing point.

One disadvantage of rapidly hardening foam, is the inherent clogging and hardening of any portion of the mixture that has not been expelled from the device. In devices designed for repetitive use where the flow of chemical compounds is not continuous, passageways and mixing chambers will clog. Disposable systems using volumetric control mixing technology can often be cost prohibitive when the mixing technology must be discarded. In International Patent Application No. PCT/IL2005/000356, a hand-held device is shown with an improved mixing and foam quality for intermittent use. As shown in this reference reproduced herein as FIG. 1, instead of using a different motor to regulate the flow of the chemical component for each of the two reservoirs, motor AA is used to push out the chemical component on both reservoirs BB, CC, at the same rate using push rods DD, EE, with a symmetrical effect on both reservoirs. The second motor FF is used at the interface between the chemical reservoirs BB, CC, and a mixing chamber GG to provide a more accurate and/or efficient control of the volume released. In this case, motor AA creates a pressure in the reservoirs BB, CC, and motor FF is used mostly for volumetric control of the pressurized fluid driven out by the force from motor AA. For example a gear pump with volumetric control can be used as part of the mixing chamber GG energized by the motor FF. FIG. 1 also shows the use of heating coils HH next to the chemical reservoirs BB, CC to warm the chemicals to help with the foam forming process.

PCT/IL2005/000356 teaches the use of a hand held foam making device where small rigid tubes are used along with a gear pump where the volume is pushed out by rotating two cams. The device can be opened and the mixing chamber is part of a nozzle system. PCT/IL2005/00355 also incorporated herein by reference teaches specific embodiments of a foam dispensing nozzle II that may be used in the system shown at FIG. 1 and described in PCT/IL2005/000356. Much like the replacement of a pump can be costly, the replacement of a nozzle assembly II can also be cost prohibitive for the overall system and may require dissembling, removal of the pressure in the system. PCT/IL2005/00355 shows a the specifics of this type of insert formed inside the nozzle assembly where both channels between the mixing chamber and the reservoirs are in a V shape, and where a lateral biasing element forces the V shape channels flat when pressure is removed.

The hardening foam for packing has a plurality of commercial application, one of which is packaging and shipping of fragile items. In one embodiment, two flexible plastic bags are used to confine the solidifying foam as it expands and hardens. In an empty box, a first bag is filled with a pre-determined volume of expanding foam. The bag is rested in the bottom of the box and the fragile item is placed in the foam as it hardens. To complete protection, a second bag may be used cover the upper portion of the fragile item not covered by the expanding foam of the first bag.

Application No. PCT/IL2005/000355 is directly more specifically to several possible technologies of nozzles that may be used to squeeze out from the mixing chamber any foam before it solidifies in place. As described in these references, this technology allows for the use of the mixing nozzle up to 50, 100, or even 200 times before it must be replaced. As this type of nozzle becomes clogged with use, the flow of liquid is difficult to control and the resulting foam bags can vary in volume. Further, when a new nozzle must be inserted, the system must be flushed or cleaned and some of the liquids may be in contact with the user. What is needed is a system designed for simple replacement of a mixing nozzle, as well as a system with a nozzle having a very small geometry to limit the costs and waste associated with use of multiple nozzles over time.

FIG. 2 also from the prior art is a reproduction from PCT/IL2009/001070 illustrating a gear pump system JJ formed with a casing KK covering gears (not shown) rotating in the casing KK coupled to drive shafts LL activated by a motor via the motor-gear coupling elements MM. The chemical reservoirs are connected to inlets NN. The rotation of the drive shafts LL by the external pump rotates gears (not shown) inside the casing KK who in turn force some of the chemicals from the chemicals reservoirs to travel past the inlets NN down into the mixing chamber OO shown. PCT/IL2009/001070 further shows how the gear pump system JJ can be used as a filling interface to fill a plurality of bags attached in a roll and slid over a guide rail.

What is needed is a new generation of foam dispenser system where a foam producing device can be improved so it no longer requires long and complex periods of maintenance to repair, unclog, or change a nozzle assembly. What is also needed is a foam producing device and system capable of adaptation for use of multiple simplified plastic bag interfaces for allowing a user to use individual bags, not rolled bags of different sizes and shapes. Further, what is needed is a foam dispenser with a pump assembly with a nozzle assembly that may be adapted for different uses in a commercial environment.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is a schematic representation of a foam dispenser with pump and nozzle from the prior art.

FIG. 2 is an isometric representation of a gear pump system from the prior art.

FIG. 3 is a perspective illustration of a new type of foam dispenser according to an embodiment of the present disclosure.

FIG. 4 is a back isometric view of the foam dispenser of FIG. 3.

FIG. 5 is a front isometric view of the foam dispenser of FIG. 3 with the head portion in a lowered position.

FIG. 6 is an isometric view of the foam dispenser of FIG. 3 with the head portion in an open configuration without the pump assembly.

FIG. 7 is an isometric view of the foam dispenser of FIG. 3 with an open head portion with a translated base door for illustrating a storage compartment.

FIG. 8 is an isometric view of the foam dispenser of FIG. 3 illustrating a warming element inside the base portion.

FIG. 9 is a side view of the foam dispenser of FIG. 3.

FIG. 10 is a front view of the foam dispenser of FIG. 3.

FIG. 11 is a top view of the foam dispenser of FIG. 3.

FIG. 12 is an isometric view of the head portion of the foam dispenser of FIG. 3.

FIG. 13 is an isometric view of the base portion of the foam dispenser of FIG. 3.

FIG. 14 is a plan view of the base portion of FIG. 13.

FIGS. 15-16 are isometric illustrations of the stand of the foam dispenser of FIG. 3.

FIG. 17 is an exploded view of a first type of detachable nozzle assembly according to an embodiment of the present disclosure.

FIG. 18 is an isometric illustration of the detachable nozzle assembly of FIG. 17 in an assembled configuration.

FIG. 19 is an exploded view of a second type of detachable nozzle assembly according to another embodiment of the present disclosure.

FIG. 20 is an isometric illustration of a third type of detachable nozzle assembly according to another embodiment of the present disclosure.

FIG. 21 is an isometric illustration of a first type of pump assembly equipped with the detachable nozzle assembly of FIG. 17.

FIG. 22 is an exploded isometric illustration of another pump assembly equipped with the detachable nozzle assembly of FIG. 19.

FIG. 23 is an exploded isometric illustration of a third pump assembly equipped with the detachable nozzle assembly of FIG. 20.

FIG. 24 A-B are animated views of a bag insert slid into the detachable nozzle assembly of FIG. 17.

FIG. 25 A-B-C are animated views of the connecting ring of the pump assembly of FIG. 23 in different positions.

FIG. 26 A-B are animated views of the handle of the pump assembly of FIG. 22 in the latched and unlatched configurations.

FIG. 27 is an isometric view of the pump assembly of FIG. 21 with the nozzle assembly in an unlatched configuration.

### DETAILED DESCRIPTION OF THE INVENTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

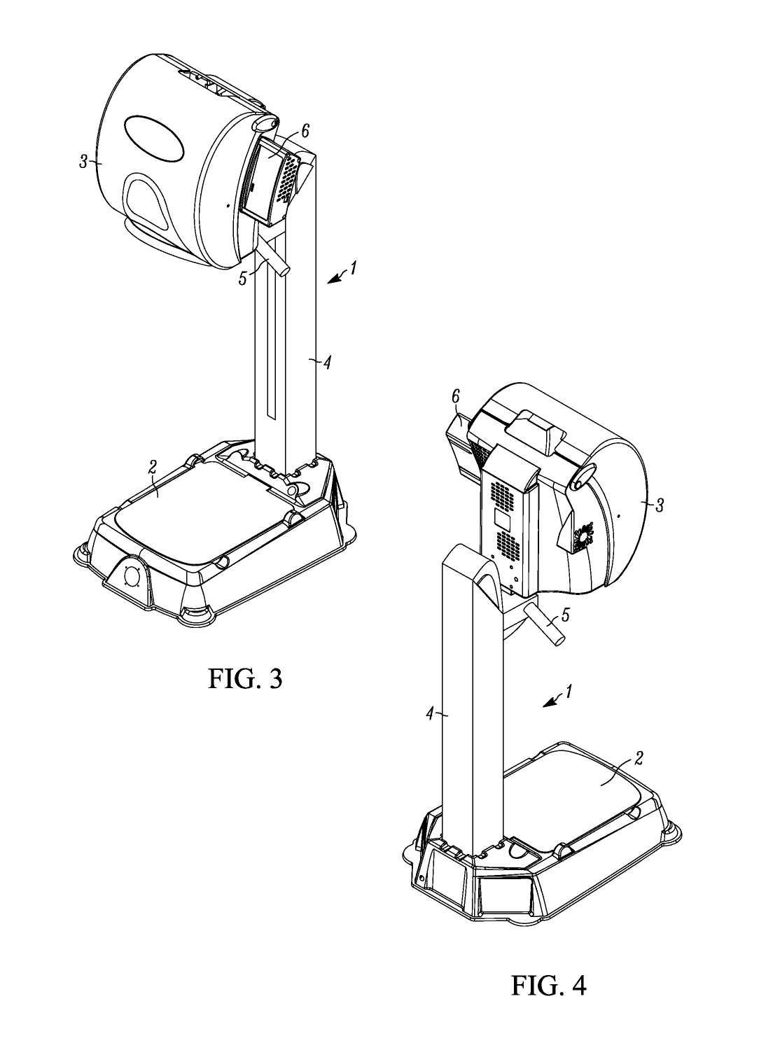

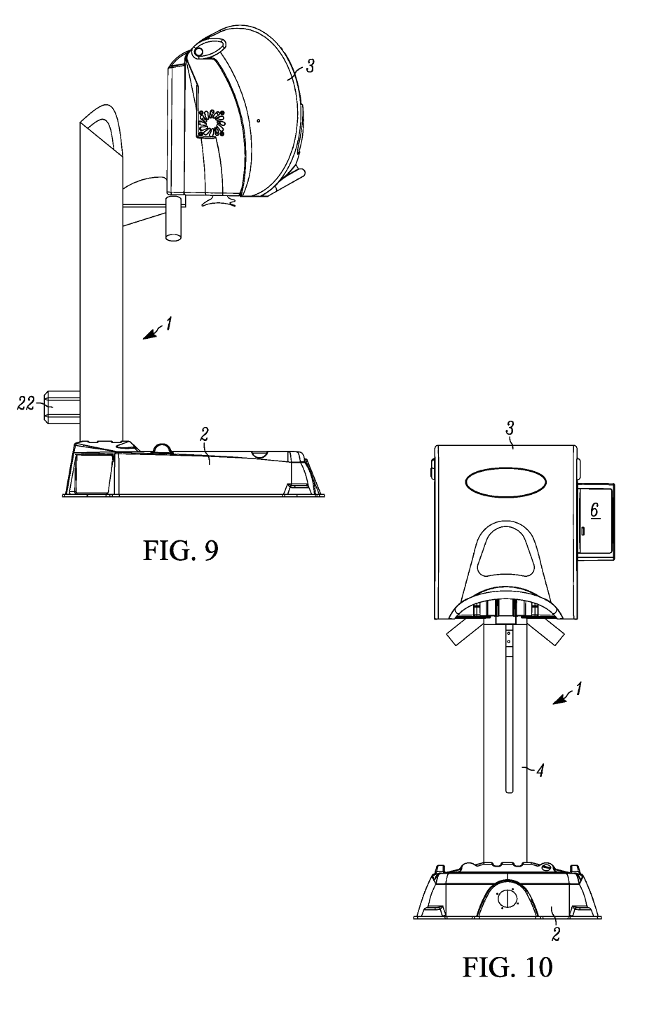

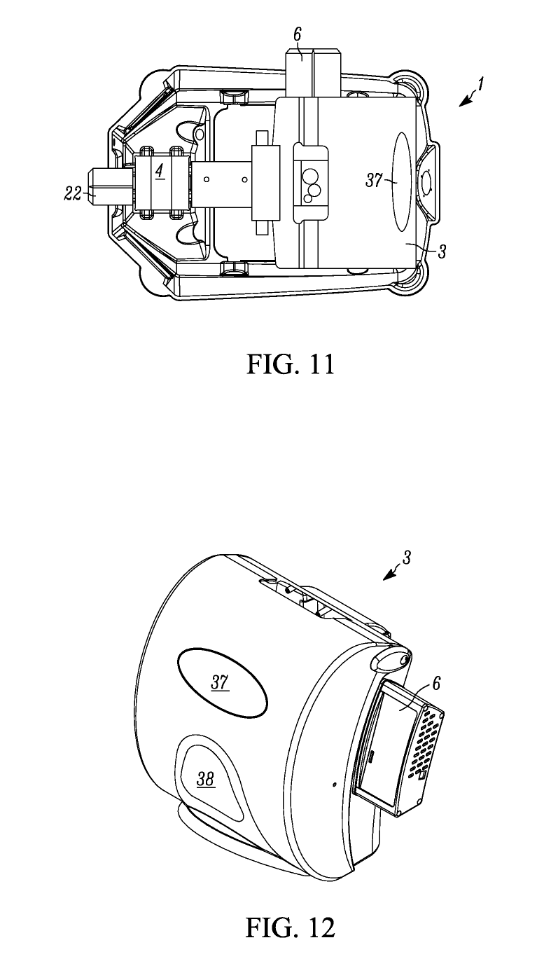

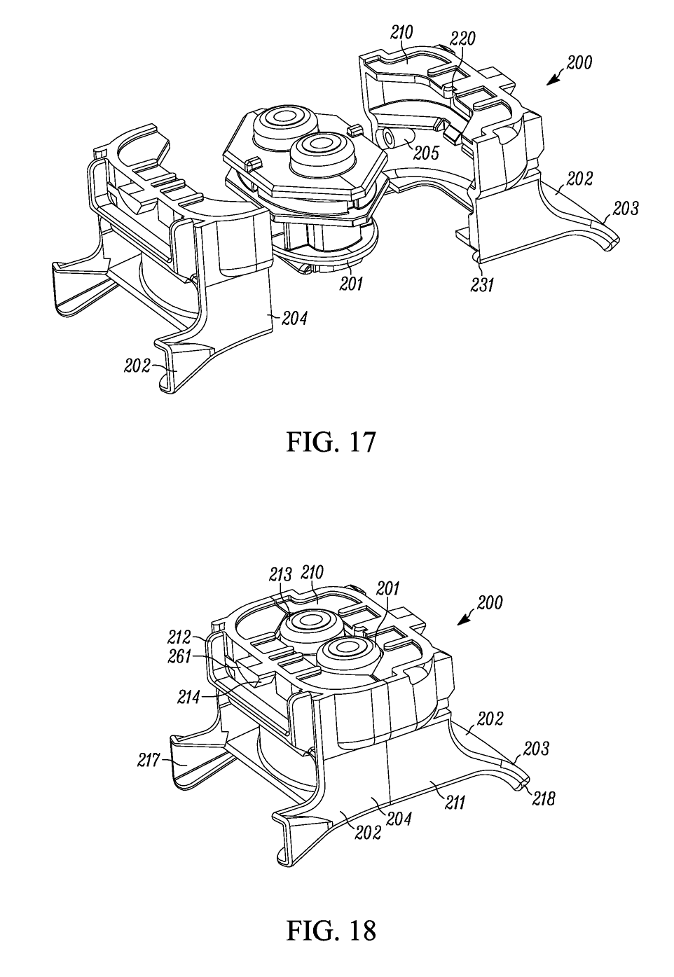

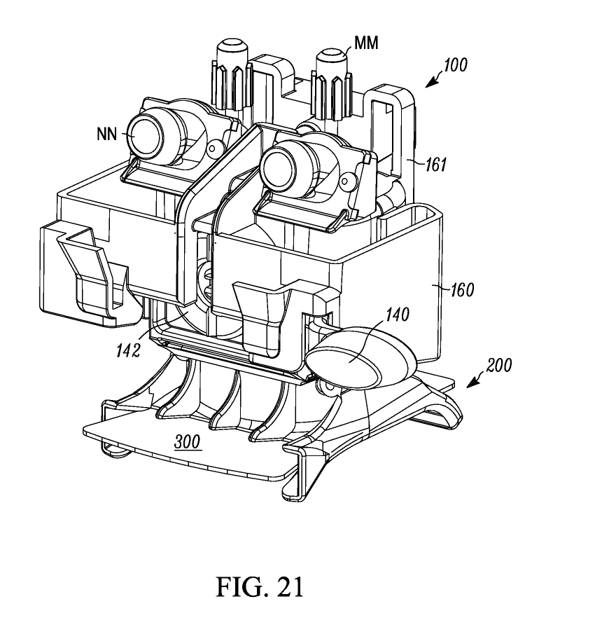

FIGS. 3-16 show different illustrations of a foam dispenser 1 with in a head portion 3 designed to hold one of a different number of pump assemblies 100, shown with greater detail at FIGS. 21-23. These pump assemblies 100 are each equipped with one of a number of detachable nozzle assemblies 200 shown at FIGS. 17-22 designed for connection with the pump assembly 100. While this disclosure focuses mostly on teaching a standing foam dispenser 1 as one possible type of technology where a pump assembly equipped with a detachable nozzle assembly can be used, one of ordinary skill in the art will understand that this technology can be used on any type of foam dispensing equipment, process, and system including but not limited to hand held dispensing guns, automated dispensing systems, and industrial dispensing processes. For the purpose of clarity, different nozzle assemblies 200 and different pump assemblies 100 are numbered using only one number to prevent specific referencing. One of ordinary skill in the art will recognize that when reference is made to any nozzle assembly, reference is made to any nozzle assembly, including but not limited to the three different embodiments shown with particularity in the figures.

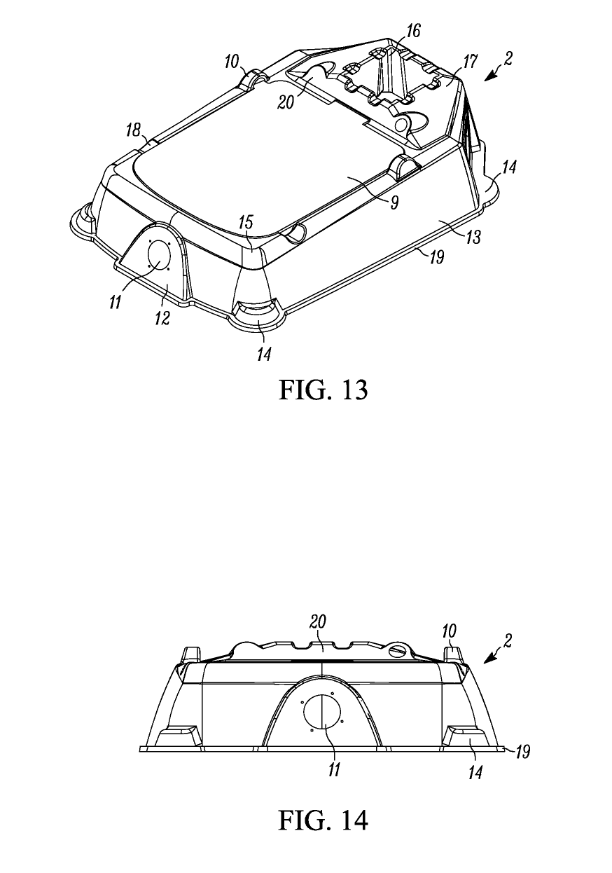

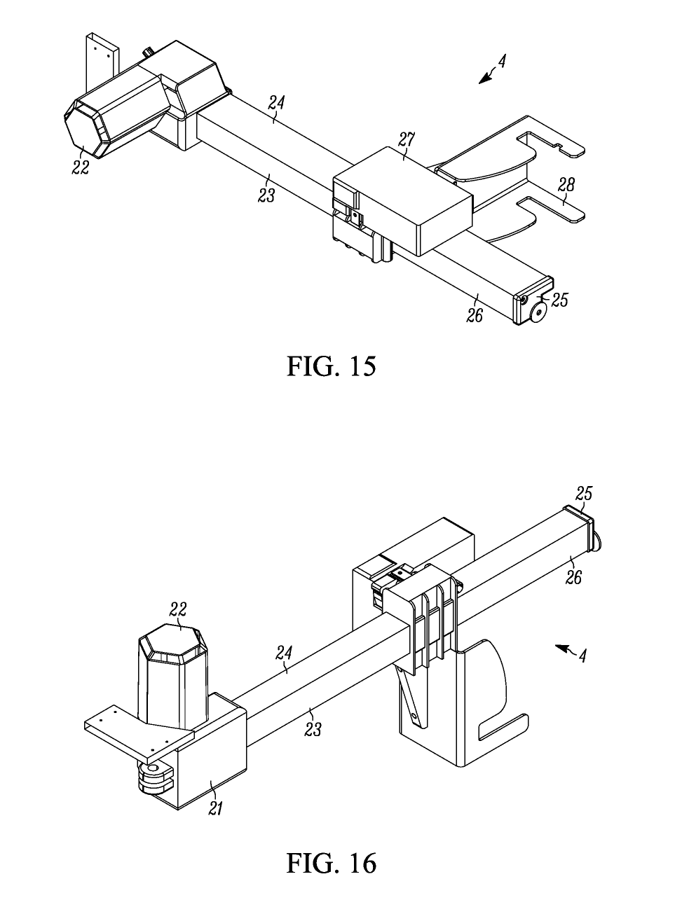

The standing foam dispenser 1 shown at FIG. 3 includes a base portion 2, a head portion 3 attached via a stand 4 where a handle 5 is used for lifting or tilting the head portion 3 in relation with the base portion 2. FIGS. 3-11 show generally the standing foam dispenser 1 as a whole. FIG. 12 is a specific view of the head portion 3, FIGS. 13-14 are illustration of the base portion 2, and the stand 4 that connects the head portion to the base portion in FIGS. 3-11 is shown at FIGS. 15-16.

While the dispenser 1 is shown with a head portion 3, a base portion 2, and a stand 4, one of ordinary skill will understand that these different constituents/elements may be changed or modified based on the nature of the dispenser to be used. For example, in a wall mounted dispenser, there may be no need for a stand and a base. If the dispenser is a hand held gun, there may be a need for an additional table-top base where the gun may be clipped in. The terms base 2, head 3, and stand 4 while shown with one specific embodiment, may be made according to a wide range of possible designs known to one of ordinary skill in the art.

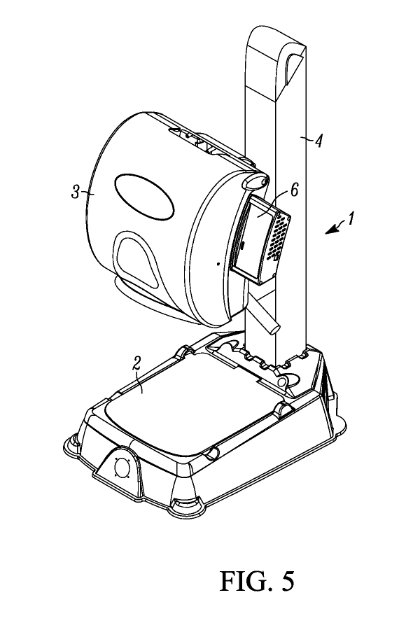

FIG. 3 shows the configuration where the head portion 3 is in an upwards position distant along the stand 4 and at FIG. 5 the head portion 3 is in a lower position along the stand 4. The movement of the head portion 3 in relation to the base 2 is done manually using a handle 5, a latch or any other known mechanical activation system. The relative movement along the stand 4 can also be performed automatically using an automated and preprogrammed software interface connected to a motor 22 as shown at FIG. 16 as part of the dispenser 1. In the field of commercial dispensers, the external industrial environment can sometimes difficult for fully automated systems, it is sometimes preferable to use a manual or partially manual system or a system with as much manual functions as possible. For some dispensers, it may be preferable to use a computer processing unit (CPU), connected to a memory chip for uploading and running a computer software within the CPU and the dispenser 1. A user interface such as the screen 6 shown at FIG. 12, is used to operate or program and the dispenser 1. The animated dispenser may include an external connecting port for maintenance and programming of the computer software, and for the management of hardware mounted in the dispenser 1 (not shown). FIGS. 3-11 show a mostly manual dispenser 1 where a handle 5 is used to operate the head 3 and a knob 11 is used to warm the base compartment.

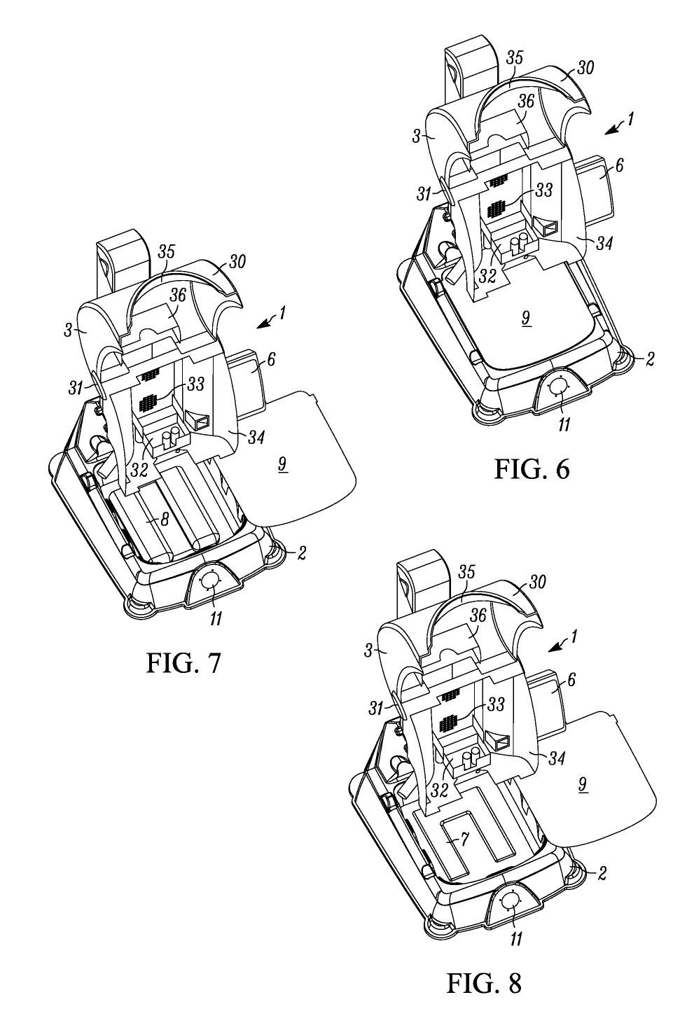

The automated system of the dispenser 1, as is generally known can operate using an autonomous power source like a battery, infrared waves, or a solar power cell. The dispenser 1 automated system can also be connected via a plug to a local power network. FIG. 8 shows a configuration where a heating element 7 is connected to the automated system can maintain a minimum temperature to recharge bags 8 shown at FIG. 7. Once again, to manage the heating element 7, temperature sensors, a programmed timer in the software, an on/off button 11 as shown at FIG. 7 may be used. One of ordinary skill in the art of software into hardware devices will understand how the dispenser may be automated and regulated. FIGS. 6-8 show the dispenser 1 with the base door 9 in a closed configuration (FIG. 6), in the translated and not opened configuration revealing recharge bags 8 in the storage space (FIG. 7), and finally a view where the recharge bags 8 have been removed to reveal the heating element 7 (FIG. 8).

The base portion 2 shown at FIGS. 13-14 includes a door 9 that pivots at a hinge 10 or slides for protecting a compartment also described as a storage space below the door 9 as shown at FIG. 7. A tab 18 located on the side of the base portion 2 allows for a user to get access and lift using a finger the door 9 by pivoting the door 9 at the hinge 10. FIGS. 7-8 show a base portion 2 with a door 9 moved to the side for drafting clarity. FIG. 14 shows a knob 11 for controlling the temperature of the heating element 7, where the heating element 7 inside the base portion 2 is controlled directly by the knob 11 instead of by any automated system on the dispenser 1. For example, the knob 11 can be a simple on/off switch or a timer switch connected to a power source as described above.

The knob 11 as shown is located on a curved design element 12 made in the molding 13 of the base portion 2. Other structural elements can be placed on the base portion 2 such as, for example, feet 14 to increase stability on a base lip 19, ribs or angles 15 to enhance the rigidity of the base portion 2. The base portion 2 as shown also includes a back opening 16 for sliding in one end of the stand 4. In one embodiment, the base 2 is a plastic molded thin shell designed for the specific type of dispenser 1. In an industrial environment, the base can be made to sustain great weight and shocks and may be made of a material capable with a strong resistance to fracture and deformation. For example, a dispenser 1 can be designed with a base 2 slid into a ground opening (not shown) so the door 9 is at the same height as the floor and the knob or control is also accessible from the top portion 17 of the base. A support 20 is used to rigidify the base 2 and also to serve as holder of the door 9 in the open configuration.

FIGS. 15-16 shows the stand 4 as part of the dispenser 1. The stand 4 at a bottom end 21 is slotted into a back opening 16 of the base portion 2. The stand 4 can be an automated stand as illustrated in FIGS. 15-16 with a motor 22 for sliding up and down a support rack 23 along the square shape support 24. As shown, a cap 25 is slid into the top end 26 of the stand 4. In one embodiment, the stand is square is shape and made of a strong and durable material such as an aluminum profile, a folded stainless or painted sheet, or a galvanized sheet of metal. Once again, while one possible embodiment is shown, what is contemplated is the use of any type of stand made of any geometry capable of holding the head portion 3. In another embodiment (not shown), the stand 4 has a bottom end 21 capable of being secured on any surface directly without a base portion 2. The head portion 3 is shown includes a connector 27 slidably connected to the square shape support 24 for movement from the top end 26 to the bottom end 21. The connector 27 also includes L shape plates 28 to holding the head portion 3. While one type of connector 27 is shown, what is contemplated is the use of any type of connector for holding any type of head portion 3.

At FIGS. 6-8, the head portion 3 is shown in an open configuration where a face panel 30 is rotated upwards by approximately 180 degrees at a pivot 31. The head portion 3 is designed to hold the chemical product bags (not shown) connected to the upper portion of the pump assembly 100 as shown on FIG. 21. These bags are locked in place in the interface 32 shown without the assembly 100. Air holes or vents 33 are made in the different portions of the head portion 3 to allow cooling down and natural convection and ventilation as needed. In the case of a flexible chemical product bag, the face panel 30 and the back panel 34 must be designed to offer some level of support to the bag, for example with the use of a latch connected to the bag, lateral ribbing or support ledges (not shown).

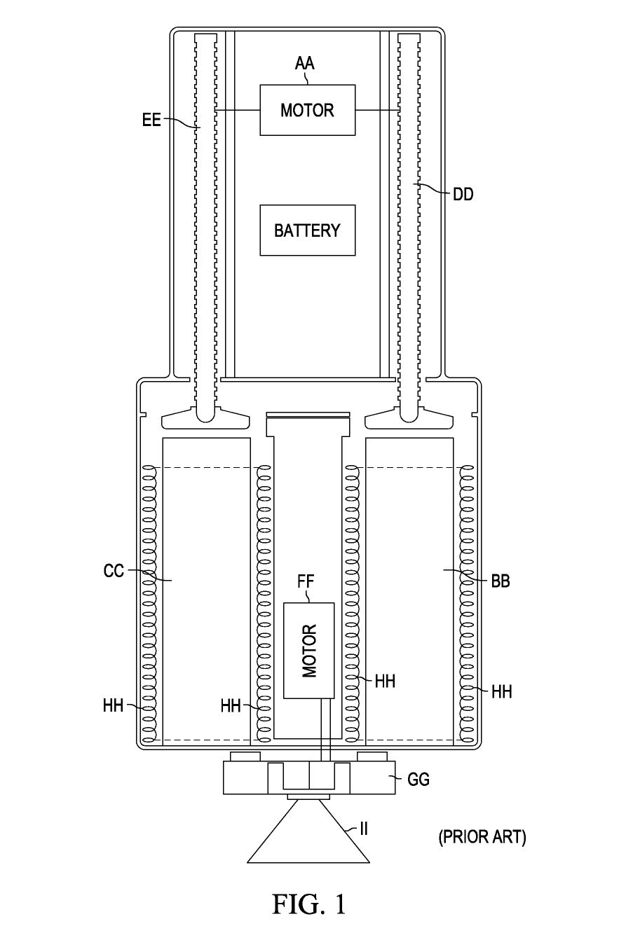

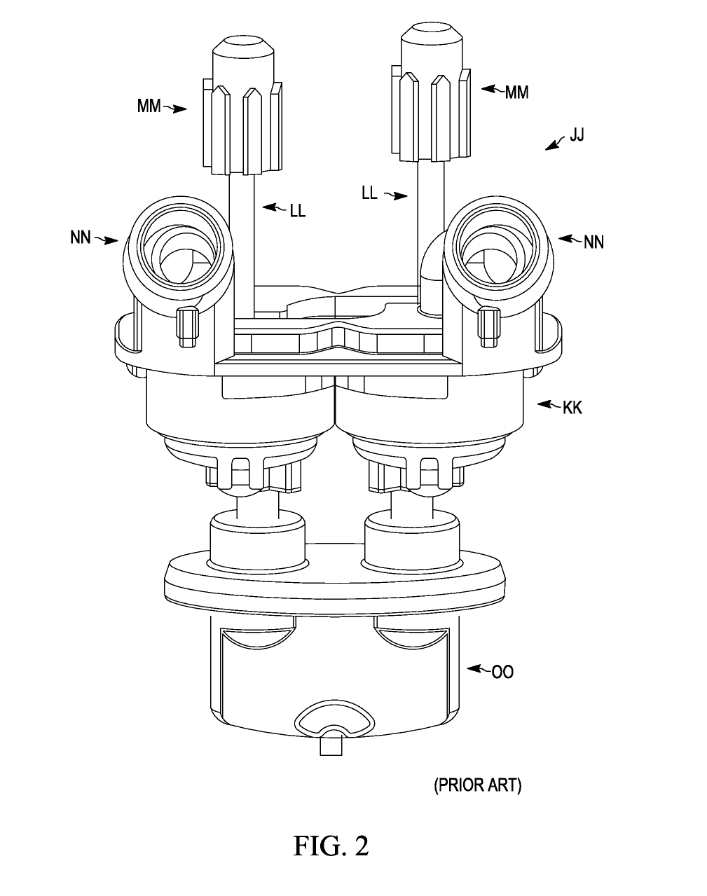

The face panel portion 30 also includes a rounded bottom lip 35 to allow manual access to a user of the dispenser 1 to the pump assembly 100 as shown at FIGS. 21-23, and therefore the nozzle assembly 200 as shown at FIGS. 17-20. Either the face panel 30 or the back panel 34 may include a casing 36 for holding a motor (shown at FIG. 1) for energizing the pump assembly or the CPU (not shown).

The pump in the casing can also be manually activated via a button or using the software interface and the LCD screen 6. These automated features are not shown as the manual version of the dispenser 1 is shown. On the head portion 3 as shown with greater detail at FIG. 12, a screen 6 such as a touch sensitive LCD, or a series of programmed buttons (not shown) can be used to operate the dispenser 1. Shown with greater detail on FIG. 12, the face panel 30 can also include on its external surface a window 37 to allow users to see the remaining volume of products in the chemical bags inside of the head portion 3 and an instructional display 38 for guiding the user of the dispenser 1. Other alternate embodiments include chemical product bags with an external surface capable of acting as the head portion 3.

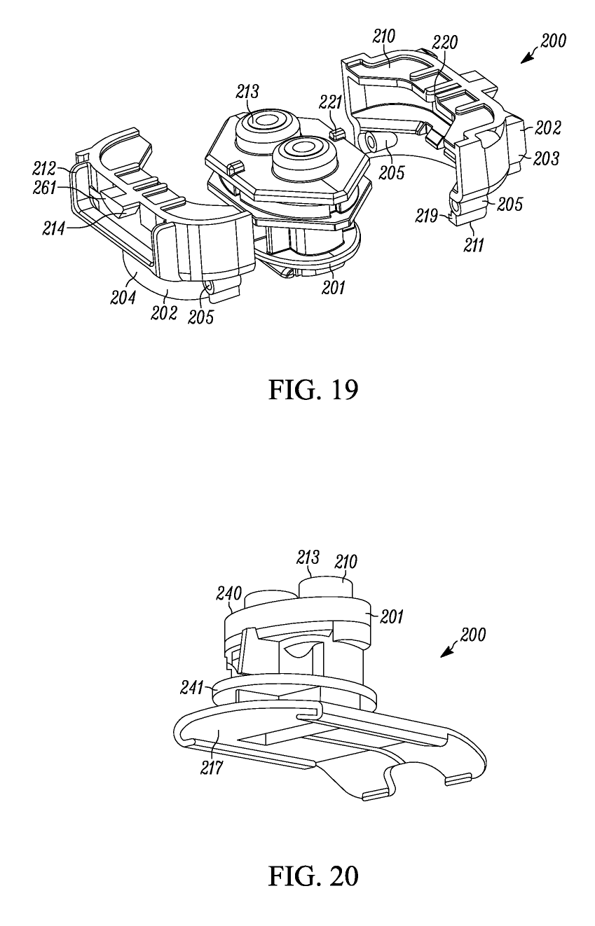

FIGS. 17-20 show three different types of detachable nozzle assemblies each numbered 200. The first is shown at FIGS. 17-18, the second type shown at FIG. 19, where both of these have a nozzle 201 encased in a nozzle casing 202 made of mating pieces 203, 204. In contrast, at FIG. 20, third type of nozzle assembly 200 is made of a nozzle 201 adapted to function without a casing when latched onto a pump assembly 100 described below with greater detail.

The nozzle 201 contains a mixing chamber and is designed to be compact and of simple technology for easy removal from the nozzle casing 202 and the pump 100 and allow for possible discard. The use of a nozzle casing 202 allows for the discard of only the nozzle 201 by replacing the nozzle 201 in the existing nozzle casing 202 before the nozzle assembly 200 is connected back in place.

The nozzle casing 202 is illustrated for one type of nozzle 201 in the opened configuration at FIG. 17 and in the closed configuration at FIG. 18 for the same nozzle 201. The casing 202 is opened either by unclipping both parts or removing a fixation means such as a screw, a bolt, a magnets, a clip, or any similar fixation means. While a specific fixation means is not shown at FIG. 17, what is shown is a base 205 for holding a screw or a bolt. One of ordinary skill in the art will understand that while one fixation means is shown for the casing 202, what is contemplated is the use of any mechanical means of fixation to secure the nozzle casing 202 around the nozzle 201.

The use of a nozzle casing 202 allows to minimize the piece that contains the mixing chamber that ultimately is subject to clogging and must be discarded during a maintenance. The nozzle casing 202 as shown is made with two interlocking pieces 203, 204 surrounding the nozzle 201. What is contemplated is the use of any type of casing including a single piece casing, a clipped in casing, a multi-piece casing, or even a deformable rubber casing in which the nozzle 201 can be adapted to be mounted on a pump assembly 100. At FIG. 20, the external surface of the nozzle 201 is adapted to act as the nozzle casing 202.

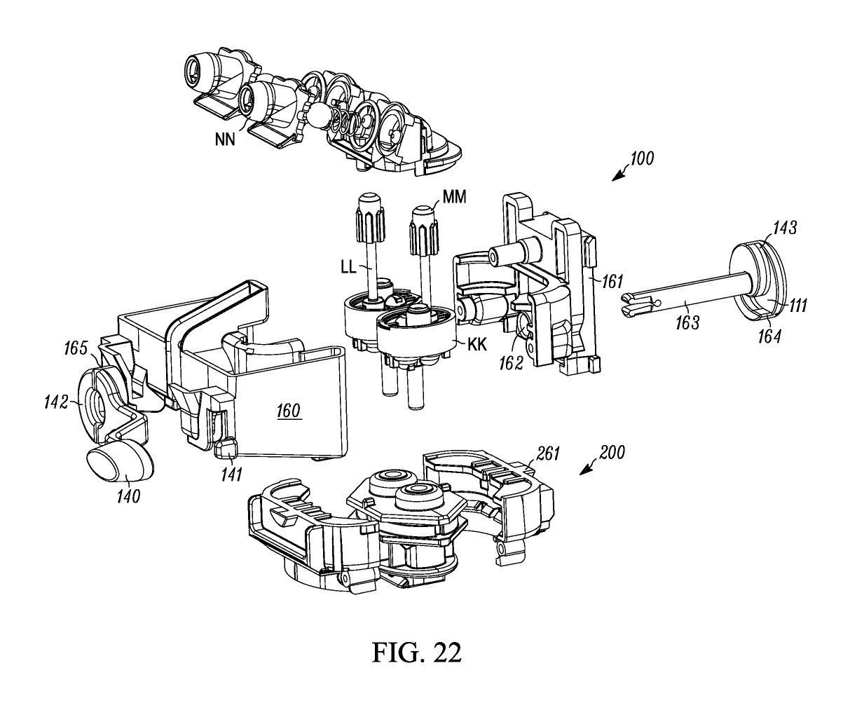

The nozzle assembly 200 includes a top end 210 for adaptation to a pump assembly 100 and a bag interface end 211 at the opposite end of the top end 210. The top end 210 includes on the casing 202 tabs 261 and ledges 212 that are slid into mating openings 111 on the pump assembly 100 on which it is placed as shown at FIG. 22.

An upper portion 213 of the nozzle 201 can be rounded or have a geometry designed to better adapt to a sealing member (not shown) to prevent the release of chemical products as they are directed down into the upper portion 213 of the nozzle 201, or instead of a sealing member, the bottom surface 103 of the pump assembly 100 as shown for example at FIG. 22 can include guide tubes 104 slid partly down into passages 215 in the upper portion 213. Either a seal (not shown) or a guide tube 104 is designed to prevent leakage of the chemical products outside of the nozzle 201 and into other areas of the nozzle assembly 200.

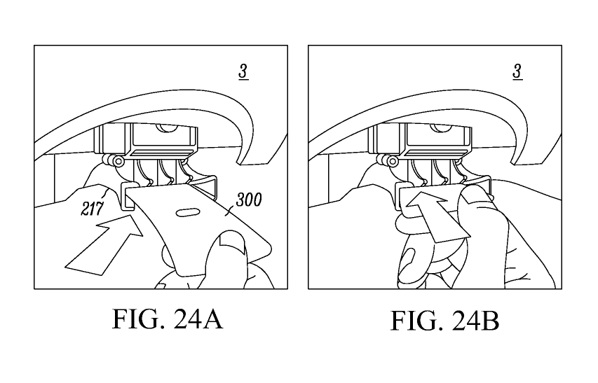

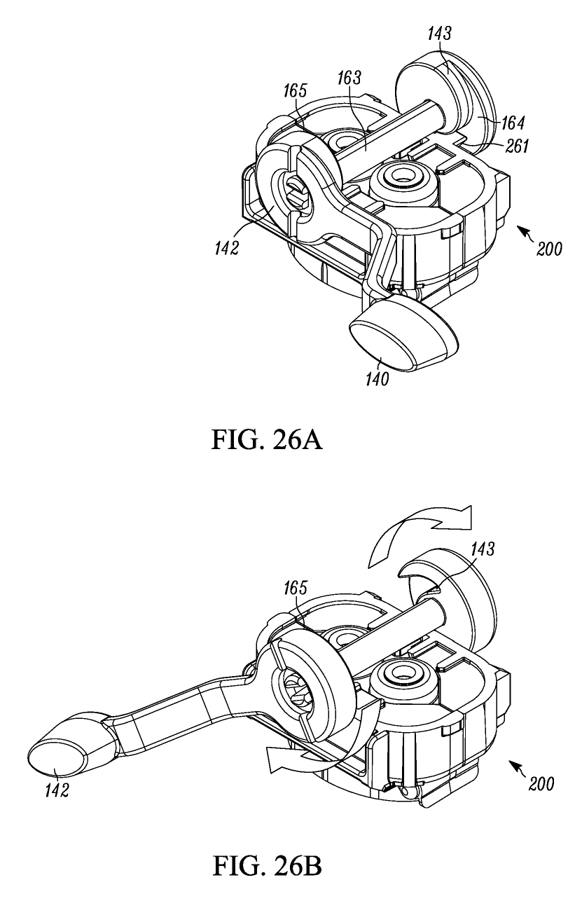

The tab 261 is shown in the shape of a polygonal volume with angled lateral faces 214 designed to push upwards and centers against element 164 in FIG. 22 as the handle 140 is rotated to the locked position as shown at FIG. 26B. The bag interface end 231 as shown at FIGS. 17-18 can include a guide 217 as shown at FIG. 18 for sliding a card shape bag interface 300 as shown at FIG. 24 into place. The card shape bag interface 300 is made to slide inside the guide 217 until it reaches a blocking point 218 located inside the opposite end. The same interface is shown at FIG. 20. At FIG. 19, a L shape guide 219 can be used and a user will simply hold an open bag below the bag interface end 231. In the embodiment shown at FIG. 17, the top end 210 also includes an opening 220 for guiding a guide rail 221 on the upper portion 213 of the nozzle 201 in place. One of ordinary skill in the art will recognize that the nozzle casing 202 can include many different features to help mate the nozzle 201 in place as an adaptor piece. What is contemplated is the use of the nozzle assembly 200 that can be detached or adapted to the pump assembly 100 for easy access and easy removal of the nozzle 201 and replacement. The nozzle assembly 200 can also serve as a way to adapt a dispenser 1 to different types of bags by changing the bag interface 211 as needed.

FIG. 20 shows a nozzle assembly 200 where the nozzle 201 includes a top end 240 with a mating interface for connection and seal directly to the bottom 103 of a pump assembly 100 for sliding a card shape bag interface 300. The bottom end 241 of the nozzle 201 includes a guide 217. The top end 240 may also include a flat surface used to collect and confine any leaks from the seal between the upper portion 213 and the pump assembly 100.

Having described in full the dispenser 1 as shown at FIGS. 3-16, and three different nozzle assemblies 200 as shown in FIGS. 17-20, we now describe how each of these three nozzle assemblies latch or connect to a different type of pump assembly 100 shown at FIGS. 21-27. An isometric view of each of the three pump assemblies 100 are shown at FIGS. 21-23.

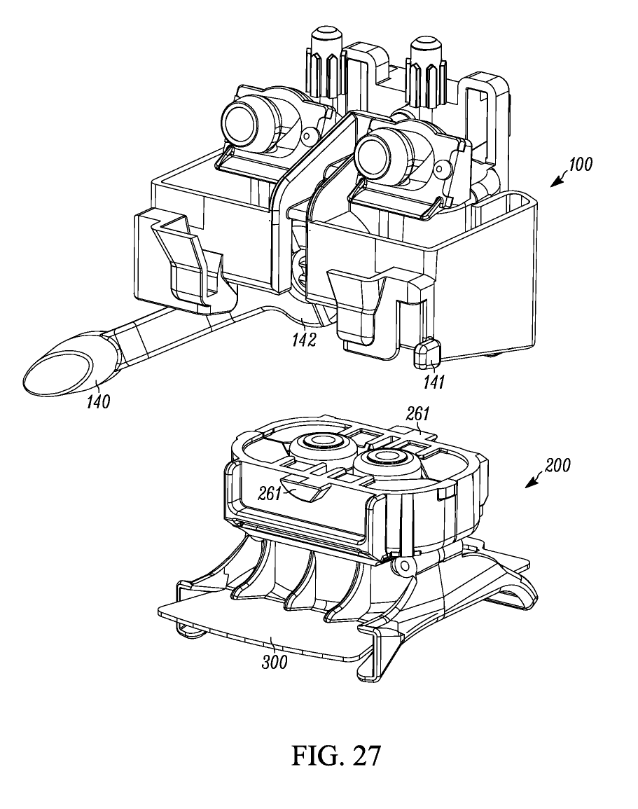

FIGS. 21, and 27 show respectively the first embodiment of the pump assembly 100 equipped with the nozzle assembly 200 as described above and shown at FIG. 18. At FIG. 21, the system is in a locked configuration and then at FIG. 27 the system is in an unlocked configuration where the handle 140 is rotated downwards passed the holding tab 141. When the handle 140 is rotated downwards as shown by the illustrations of FIG. 26, the inside surface of the handle support 142 and the back support 143 includes a mating opening 111 (shown at FIG. 22) and rotates as it releases the tabs 261 and ultimately the nozzle assembly 100. While one type of connecting mechanism is shown, what is contemplated is the use of any mechanical means to latch or connect a nozzle assembly 100 to a pump assembly 200, including but not limited the use of magnets, clips, a press-push system, a series of sliding drawers, rails, fast lock fastening means, Velcro, or even a snap in mechanism with release tabs. FIG. 27 shows the handle 140 in an open configuration releasing the nozzle assembly 100. FIGS. 26A and 26B illustrate the specifics of the connecting mechanism shown generally at FIG. 22.

The pump assembly 100 of FIG. 21 include a front and back casing 160, 161 with an opening 162 for the passage of a axis 163 connected to two end plates 164, 165 as shown at FIG. 22. The handle 140 can be rotated as illustrated by arrows in FIGS. 26A-B, the two plates 164, 165 move and release the tabs 261 located on the nozzle assembly 200. While one connecting mechanism is shown, other systems are contemplated.

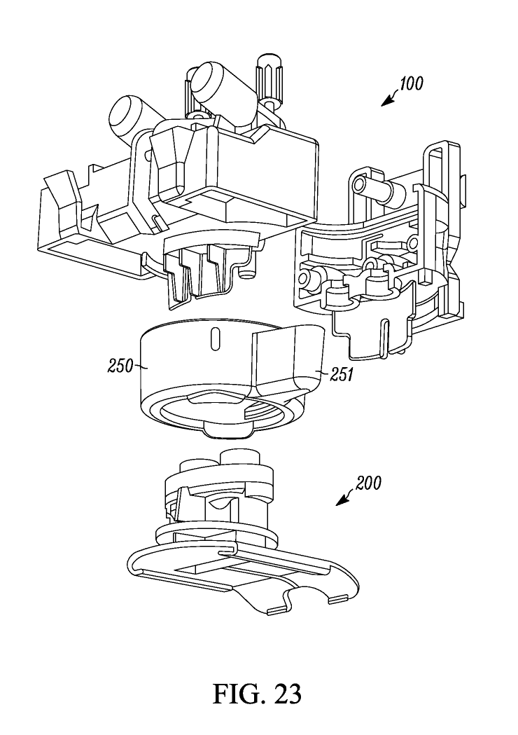

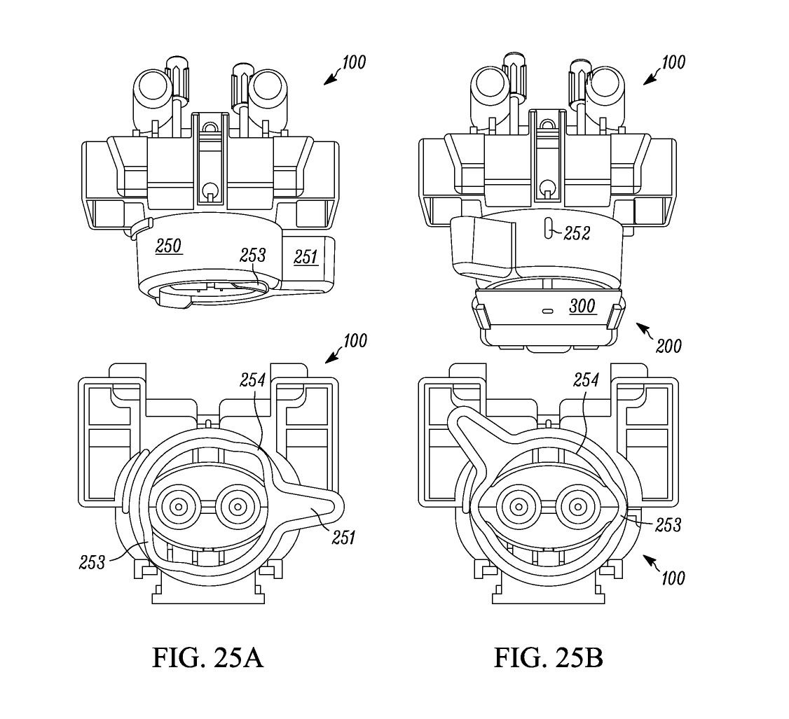

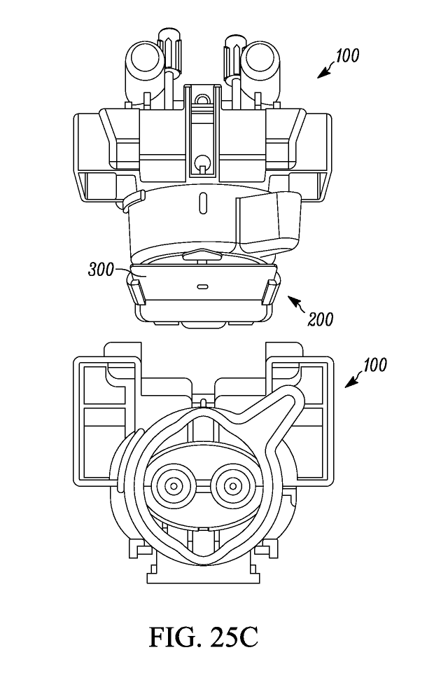

FIG. 23 shows one other possible system including a connecting ring 250 is used to help guide the nozzle assembly of FIG. 20 in place. FIG. 25A shows the push bar 251 on the external surface of the ring 250 is in a locked configuration without the nozzle assembly 200 in place. At FIG. 25B, a user will first rotate the push bar 251 to the location shown there the indicator 252 is aligned. Bends 253 in the inner radius 254 of the ring 250 are then aligned so the nozzle assembly 200 of FIG. 20 can be slid into place as shown as the top end 240 can be slid past the inner radius 254 of smaller size than the radius of the top end 240. Finally, to secure the nozzle assembly 200 in place, the bends 253 are then pushed as far away as possible from the open configuration, in this case at a ninety degree angle by rotating the ring 250 clockwise until the second indicator 253. Once again, these possible connecting mechanisms shown are only illustrative embodiments of possible systems for adapting the nozzle assembly 200 to the pump assembly 100. One of ordinary skill in the art will recognize that this several embodiments are shown, many others are contemplated and can be used in association with this technology.

What is also contemplated is a method for replacing a detachable nozzle 100 on a foam dispenser 1, the method comprises the steps of connecting a first detachable nozzle assembly 200 to a pump assembly 100, using the foam dispenser 1 to dispense foam, remove the first detachable nozzle assembly 200 from the pump assembly 200, discarding the first detachable nozzle assembly 100, and attaching a second detachable nozzle assembly 200 to the pump assembly 100. In a subsequent embodiment, the method further includes the step of pushing a handle 140 on the pump assembly 100 past a holding tab 141 until a pair of tabs 261 on the top end of the nozzle 200 are released.

It is understood that the preceding detailed description of some examples and embodiments of the present invention may allow numerous changes to the disclosed embodiments in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A detachable nozzle assembly for a foam dispenser, comprising:
a nozzle having a top end with two passages each for receiving one of two different products, a bag interface end opposite to the top end for releasing a mixture made from the two different products, and a mixing chamber between the top end and the bag interface end, wherein the top end is adapted for connecting onto a pump assembly, and wherein the bag interface end is adapted for mating to a bag.

2. The detachable nozzle assembly of claim 1, wherein the top end includes a guide tubes inserted into the passages.

3. The detachable nozzle assembly of claim 1, wherein the nozzle is encased in a nozzle casing.

4. The detachable nozzle assembly of claim 3, wherein the nozzle casing is made of mating pieces held by a fixation means, and includes tabs and ledges for mating it mating openings on the pump assembly.

5. The detachable nozzle assembly of claim 4, wherein the tabs include angled lateral faces.

6. A foam dispenser, comprising:
a head portion with a face panel and a back panel connected to the face panel,
a pump assembly adapted to the head portion with a connecting mechanism for a detachable nozzle assembly, and
a detachable nozzle assembly comprising a nozzle having a top end with two passages each for receiving one of two different products, a bag interface end opposite to the top end for releasing a mixture made from the two different products, and a mixing chamber between the top end and the bag interface end, wherein the top end is adapted for connecting onto a pump assembly, and wherein the bag interface end is adapted for mating to a bag.

7. The foam dispenser of claim 6, wherein the connecting mechanism includes a handle with a handle support and a back support for holding tabs on the detachable nozzle assembly.

8. The foam dispenser of claim 6, wherein the connecting mechanism includes a connecting ring with a push bar and an indicator for alignment of the top end of the nozzle.

9. The foam dispenser of claim 6, further comprising a base portion connected to the head portion with a stand, and wherein the base portion comprises a heating element

10. The foam dispenser of claim 9, further comprising a CPU connected to a screen to operate the dispenser.

11. The foam dispenser of claim 6, wherein the top end includes a guide tubes inserted into the passages.

12. The foam dispenser of claim 6, wherein the nozzle is encased in a nozzle casing.

13. The foam dispenser of claim 12, wherein the nozzle casing is made of mating pieces held by a fixation means, and includes tabs and ledges for mating it mating openings on the pump assembly.

14. The foam dispenser of claim 13, wherein the tabs include angled lateral faces.

15. The foam dispenser of claim 6, wherein the dispenser is either a standing dispenser or a gun dispenser.

16. A method for replacing a nozzle on a foam dispenser having a head portion with a face panel and a back panel connected to the face panel, and a pump assembly adapted to the head portion with a connecting mechanism for a detachable nozzle assembly, the method comprises the steps of: connecting a first detachable nozzle assembly to a pump assembly, using the foam dispenser to dispense foam, remove the first detachable nozzle assembly from the pump assembly, discarding the first detachable nozzle assembly, and attaching a second detachable nozzle assembly to the pump assembly, wherein the detachable nozzle assembly includes a nozzle having a top end with two passages each for receiving one of two different products, a bag interface end opposite to the top end for releasing a mixture made from the two different products, and a mixing chamber between the top end and the bag interface end, wherein the top end is adapted for connecting onto a pump assembly, and wherein the bag interface end is adapted for mating to a bag.

17. The method of claim 16, wherein the step of connecting the first detachable nozzle assembly includes the steps of pushing a handle on the pump assembly past a holding tab until a pair of tabs on the top end of the nozzle are released.
